(19) United States
(12) Patent Application Publication
(10) Pub. No.: US 2019/0065644 A1
(43) Pub. Date: Feb. 28, 2019

(54) METHOD OF CONFIGURING A TEST DEVICE DESIGNED TO TEST AN ELECTRONIC CONTROL UNIT, AND A CONFIGURATION SYSTEM

(71) Applicant: dSPACE digital signal processing and control engineering GmbH, Paderborn (DE)

(72) Inventor: Martin KRONMUELLER, Salzkotten (DE)

(73) Assignee: dSPACE digital signal processing and control engineering GmbH, Paderborn (DE)

(21) Appl. No.: 16/119,780

(22) Filed: Aug. 31, 2018

(30) Foreign Application Priority Data
Aug. 31, 2017 (DE) 10 2017 120 013.4

(51) Int. Cl. G06F 17/50

(52) U.S. Cl. CPC G06F 17/5009

(57) ABSTRACT

A configuration system of a test device designed for testing an electronic control unit. The test device is a hardware-in-the-loop simulator or a rapid control prototyping simulator. A software model of a technical system is executed on the test device and the software model communicates via an input/output interface of the test device with a device connected to the test device. Data is electronically transmitted by the communication, wherein the configuration system has a plurality of configuration items. The configuration items are assigned technical functional properties of the test device and the test device and/or the communication between the connected device and the software model is configured using the technical functional properties. The configuration items are assigned a functional category and are structured in functional panels in the configuration system.

This nonprovisional application claims priority under 35 U.S.C. § 119(a) to German Patent Application No. DE10 2017 120 013.4, which was filed in Germany on Aug. 31, 2018, and which is herein incorporated by reference.

### BACKGROUND OF THE INVENTION

### Field of the Invention

The present invention relates to the development of control units, as are used e.g., in the automotive industry or in the aerospace industry for the control of technical systems, such as motors or brakes. In particular, the present invention relates to test devices used in the development process of the control unit.

### Description of the Background Art

The development of control units has become a highly complex process. Thus, new control units or new control functions should be tested as early as possible in the development process to check general functionality and to specify the further direction of development. Towards the end of the development process, it is important to test the already well-developed control unit as comprehensively as possible in order to make necessary modifications based on the test results before the control unit is in use or enters series production so it works as desired under all circumstances in later operation.

For the testing of control units, the methods hardware-in-the-loop simulation (HIL simulation) and rapid control prototyping (RCP) are known. In HIL simulation, an electronic control unit is connected to a test device (HIL simulator), on which, for example, a software model of the system to be controlled or regulated by the control unit is executed. The software model is also referred to as the environmental model. The test device thus simulates the physical environment of the future operation for the control unit. In the RCP, on the other hand, a software model of a control unit to be developed or improved is executed on the test device. In the case of RCP, an external system connected to the test device is then regulated or controlled via the test device by means of the model executed on the test device.

The test of a (series) control unit used in the end product is the end point of a plurality of preliminary development steps of a regulation or control to be implemented on the control unit, wherein these development steps are usually described by the so-called V-model or V-cycle.

At the beginning of the control unit development, which is essential for the functionality of many technical systems, the mathematical modeling of the control algorithm sits on a computer with a mathematical-graphic modeling environment, wherein the controller is to be regarded as part of the control unit. In addition, the environment of the control unit is mathematically modeled because the interaction between the controller on the control unit and the process to be controlled is of interest. In these functional mathematical considerations, a simulation in real time is usually not necessary (offline simulation).

In the next step, the previously designed control algorithm is transferred by means of the rapid control prototyping to a powerful, usually real-time capable hardware, which is connected via suitable I/O interfaces to the actual physical process, for example, a motor vehicle engine. As a rule, this real-time capable hardware has nothing to do with the subsequently used series control unit; it is a question of proving the basic functionality of the previously designed control in practice.

In a further step, as part of the automatic production code generation, the control is implemented on the target processor which is probably later actually used in the series control unit. The target hardware thus approximates the series control unit in this step, but is not identical to the series control unit.

In a further step, the series control unit, which is usually not available until a later stage of development, is checked by means of a hardware-in-the-loop (HIL) test. The (series) control unit physically present in this step is connected here by means of its physical control unit interface to a powerful simulation computer, often referred to simply as a simulator or test device. The simulator simulates the required variables of the real control unit to be tested and exchanges input and output variables with the control unit. The pins of the physical control unit interface of the control unit are connected with the simulator via a cable harness. Thus, it is possible in the simulation environment to simulate all the required variables, for example, of a motor vehicle engine—if needed, of the entire motor vehicle with engine, powertrain, chassis and driving distance—and to safely check the behavior of the control unit in interaction with the simulation environment.

For configurating test devices such as HIL or RCP systems, often configuration systems are used which may include, for example, configuration diagrams. The configuration adjusts the test device such that software models of technical systems can be executed on the test device and communicate electronically via the input/output interface of the test device with devices (systems to be tested) connected to the test device. Software models are created in dedicated modeling environments that are tailored to the needs of the modeling.

The known configuration systems or configuration diagrams have the disadvantage that the configuration of the test device properties in certain application scenarios is time-consuming and complicated.

In particular, it is a disadvantage that the configuration systems have a very large number of configuration items at different locations within the configuration system, which need to be changed often, resulting in a non-intuitive and slow configuration.

### SUMMARY OF THE INVENTION

It is therefore an object of the present invention to further develop the configuration process of HIL and RCP simulations and, in particular, to simplify, to make it more flexible, to make it more intuitive and to accelerate it.

In an exemplary embodiment, an object is achieved by a configuration system for a test device designed for testing an electronic control unit, wherein the test device is a hardware-in-the-loop simulator or rapid control prototyping simulator, wherein a software model of a technical system is executed on the test device and the software model communicates via an input/output interface of the test device with a device connected to the test device, wherein the communication electronically transmits data, wherein the configuration system has a plurality of configuration items, wherein the configuration items are assigned technical functional characteristics of the test device and wherein the test device and/or the communication between the connected device and the software model is configured using the technical functional properties, wherein the configuration items are assigned a functional category, the configuration items are structured in functional panels in the configuration system, wherein for each functional category, a separate functional panel is constructed in the configuration system, and each functional panel contains only configuration items whose functional categories correspond to the functional category of the functional panel, wherein the functional panels are positioned such that the positioning takes into account the temporal and/or causal sequence of the configuration steps and that the functional panels are activatable, wherein an activation of a panel activates a subset of configuration items, wherein the subset of the configuration items and the activated functional panel have the same functional categories, wherein at the same time, all other functional panels and configuration items are deactivated, as well as by a corresponding method for configuring a test device designed to test an electronic control unit by means of a configuration system.

Due to the positioning of the functional panels, taking into account the temporal and/or causal sequence of the configuration steps, this configuration system offers among other things the advantage that the functional panels make a workflow-oriented user guidance of the configuration process possible, which is simpler, more intuitive and faster than the solutions known in the prior art.

The allocation of the functional category can be done by user input or by electronically stored assignments.

Functional panels are also known as tabs.

Activating a functional panel causes configuration items with a functional category that differs from the enabled functional panel to be hidden and adjustable. The activation of a functional panel can be done, for example, by a mouse click, a keyboard command, a fingertip or voice input.

The fact that a separate functional panel is designed in the configuration system for each functional category, and each functional panel contains only configuration items whose functional categories correspond to the functional category of the functional panel, users can get a better overview of the variety of adjustable configuration items.

In an embodiment, a functional category can define the technical context of the configuration items to be configured. This allows users to quickly and easily set those properties of the test device that are closely technically related to each other.

For example, device, input/output interface, task, project, functions, signal chain, bus, multiprocessor/multicore or build can be assigned as a functional category or technical context.

The functional category device includes such properties or configuration items which adjust parameters of the device that are connected to the test device.

The functional category input/output interface includes such properties or configuration items which parameterize the physical input/output interface, e.g., with regard to the type of data transmission, the type of electrical signal to be measured or generated, the input/output interface channel used and the like.

The functional category task includes such properties or configuration items which configure tasks or model tasks. A task can be a part of a program code whose execution is controlled by a real-time operating system. A task is usually triggered or initiated by an event. In a configuration system according to the invention, various predefined tasks can be created. It is also possible to re-create application-specific tasks, e.g., input/output events. Input/output events are asynchronous events that are triggered asynchronously by an input/output function. Depending on the type of task, various parameters such as priority or a DAQ raster name can be configured.

The functional category functions includes such properties or configuration items which configure input/output functions. Input/output functions can be used to configure the logical and physical connections between the input/output interface and the model.

The functional category signal chain includes such properties or configuration items which are used to model external devices, generate input/output blocks, change input/output settings, change or delete a device mapping, generate and flexibly connect input/output access points and calculate and display harnesses.

The functional category bus includes such properties or configuration items that add or remove communication matrices, define bus configurations, map bus configurations with communication matrix elements, add and configure properties, map models via tables, assign bus access requests to bus accesses.

The functional category multiprocessor/multicore includes such properties or configuration items that define and configure model communication and associations between models, application processes, calculation unit applications and calculation units.

The functional category build includes such properties or configuration items that configure, start, and cancel the build (compiling) of the executable application process.

The positioning of the functional panels can take place partially or completely one behind the other, next to one another or one above the other. This allows for quick changing between the various functional panels.

The configuration system can be designed for the transmission of configuration data to the test device. The configuration data can be transmitted to the test device, for example, by a source code being generated from the data contained in the configuration items, which in turn is compiled into an executable application, which is then subsequently transmitted electronically to the test device for execution there.

A transmission can be effected by codegen generation and compilation from the functional properties of the configuration items, wherein the code associated with different configuration items of the same functional category is simultaneously generated, compiled and/or transmitted in the generated code and/or in the compiled code. This allows for faster and more efficient transmission and configuration of the test device.

The configuration system can assign a new functional category to a configuration item. This allows users to specify which configuration items can be activated with which functional panels.

The configuration system can be configured such that a configuration item is assigned a first and a second functional category, and the configuration system is designed for activating the functional panel of the second functional category from the functional panel of the first functional category and/or highlighting the configuration item in the functional panel of the second functional category. In general, it is possible in all embodiments that a configuration item is assigned a plurality of functional categories. In that case, it may be advantageous to be able to change between the functional panels, since the configuration item can be configured there in different technical contexts.

A method is also provided for configuring a test device designed for testing an electronic control unit by means of a configuration system, wherein the test device is a hardware-in-the-loop simulator or rapid control prototyping simulator, wherein a software model of a technical system is executed on the test device and the software model communicates with a device connected to the test device via an input/output interface of the test device, data being transmitted electronically by the communication, the configuration system having a plurality of configuration items, wherein the configuration items are assigned technical functional properties of the test device and the test device and/or the communication between the connected device and the software model is configured with the technical functional characteristics, characterized in that the configuration items are assigned a functional category, the configuration items (15-038: Properties) are structured in functional panels in the configuration system, wherein a separate panel for each functional category is designed in the configuration system, and each panel only contains configuration items whose functional categories correspond to the functional category of the panel, wherein the panels are positioned such that the positioning takes into account the temporal and/or causal sequence of the configuration steps and that the panels can be activated, wherein by activating a panel, the configuration items are activated, which are assigned the same functional categories as the activated panel, wherein at the same time, the panels and configuration items with other functional categories are deactivated.

The modifications, other properties and effects described above with respect to the configuration system of a test device designed for testing an electronic control unit are analogously applicable to said combination.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a test device;

FIGS. 2a and 2b are two schematic representations of configuration systems;

FIG. 3 is a schematic representation of configuration items; and

FIGS. 4a-4c are schematic representations of a configuration system with functional panels designed according to the invention.

### DETAILED DESCRIPTION

FIG. 1 shows a test device 100 on which a software model 103 of a technical system is executed on a calculation unit 105, wherein the software model or the calculation unit communicates via an input/output interface 102 of the test device, and an internal data connection 107 communicates with a device 110 connected to the test device. A calculation unit may be, e.g., a processor, an FPGA or an embedded PC. The communication with the test device can take place via the transmission of analog or digital electrical signals. The test device may include various hardware units (e.g., riser cards) that form the input/output interface 102. The input-output interface and the calculation unit 105 form a coherent system, but can also be spatially separated from each other and connected to each other via electronic connections.

For example, the test device 100 may be a hardware-in-the-loop (HIL) simulator. The test device 100 may also be a “Rapid Control Prototyping” (RCP) system. The test device can also be a device that is suitable for performing HIL tests or RCP tests in that a model of a technical system can be executed in the test device and this model can exchange data via input/output interfaces with a device, such as a control unit, which is connected to the test device, wherein with this data exchange, in particular the reaction of the test device to the resulting model data, which is transmitted for example in the form of electrical signals to the control unit, is analyzed.

A software model 103, such as a model of a technical system, may for example be available in the form of a software model, which is specified by a source code, for example in a high-level language such as C, C++, or in a machine language such as Assembler or an executable machine code. Using a technical model, any system can be modeled to virtually simulate it. Thus, for example, a model of a motor may be available as software, wherein the software is programmed such that during a simulation, in this case an execution of the model on a CPU or an FPGA, input parameters are processed by the software and depending on the input parameters and the properties of the model, output values are generated. An input parameter may be, for example, a voltage applied to a throttle valve of a gasoline engine and output values could in this regard be a resulting throttle valve opening angle, fuel consumption and/or a torque resulting at the crankshaft. However, the model may also be a model of a control unit to be tested or developed. In general, the software model can be understood as an algorithm for controlling, regulating or simulating the behavior of a technical system.

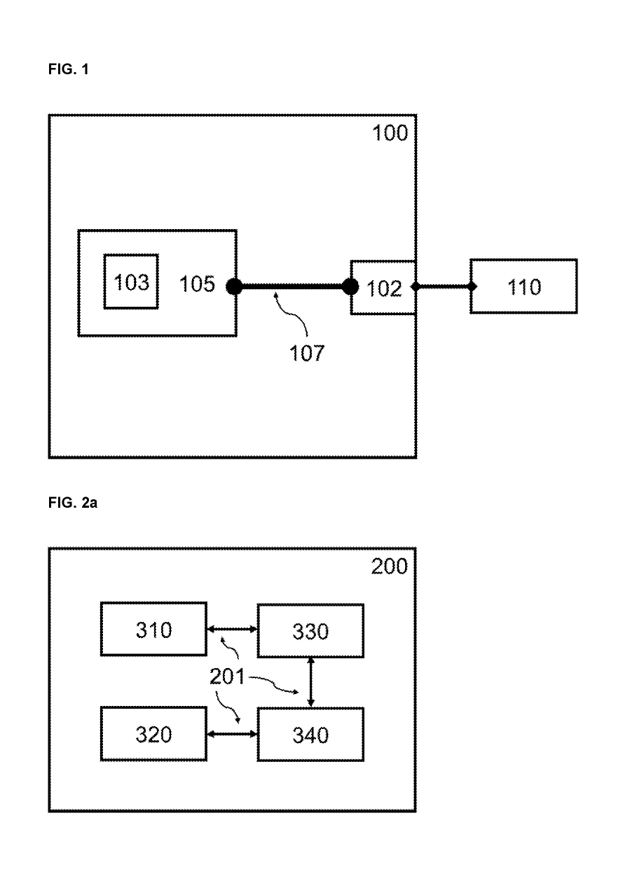

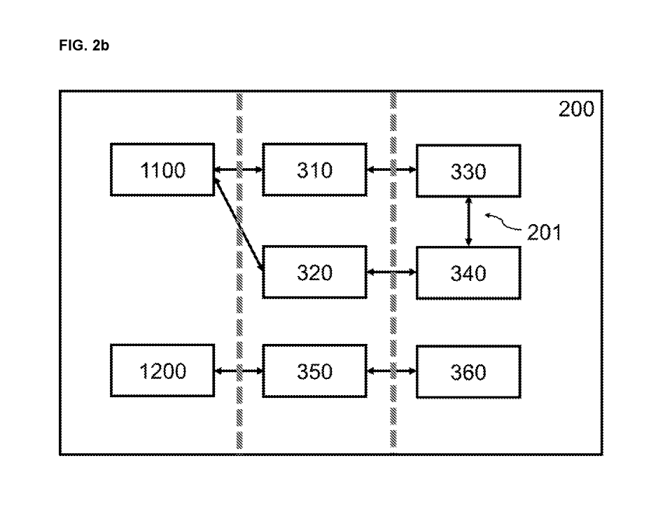

FIG. 2a schematically illustrates a configuration system 200 or a configuration diagram which contains a plurality of configuration items (310, 320, 330, 340) which can be connected to connection lines 201 for configuring the test device 100.

For example, properties and functionalities of the test device, in particular the input/output interfaces and/or the model interfaces or internal data connections 107, can be configured with the configuration items. Exemplary properties include interface types, voltage/current ranges, units, unit scales, data types, duty cycles, frequencies and/or error injections. These properties can be specified by parameters, for example by predetermined selection options from several parameters or by an option for free input of the parameters. These properties can be transmitted to the test device by means of the configuration system, where they can be stored and thus cause a configuration of the test device according to the characteristics. This configuration process can also be done indirectly, e.g., by code generation according to the characteristics, and/or subsequent compilation of the generated code, transfer of the code or the compiled code to the test device, and execution of the compiled code on the test device. The storage of the properties on the test device can therefore also take place by means of a source code or binary code.

The configuration items can be assigned physical properties of the test device with respective parameters of the properties and by means of the parameters, the communication, in particular the functionality between the connected device (system to be tested) and the software model, can be configured. In a graphical configuration environment, the individual configuration items can also be interconnected to perform a configuration of the test device. With the connection lines 201, various configuration items can be interconnected, in other words, associated or assigned. These assignments allow for various hardware components of the test device, such as processors, FPGAs, input/output boards, storage media, and the like, to be configured to exchange data, that is, to receive and transmit electrical signals.

FIG. 2b illustrates a more specific form of a configuration system 200. Here, the configuration system is divided into 3 subunits or columns, making the configuration much more efficient and intuitive for a user. In the embodiment illustrated here, in the left-hand column, the devices connected to the test device 100 are configured with the configuration items 1100 and 1200. The input/output interface of the test device is configured with the configuration items 310, 320, and 350 provided in the middle column. The properties of the models connected to the devices to be tested are configured with the configuration items 330, 340 and 360 in the right-hand column. The configuration items may be graphically connected to one or more other configuration items to set the transmission paths of physical or logical signals.

A configuration system differs from a modeling environment in that it is specifically tailored to the requirements for configuring a test device. In particular, it is thus also possible to create a documentation of the test device, to reuse configuration components or software models in different test scenarios, to execute software models from different development/modeling environments on the test device, to optimize multi-core and multi-processor uses.

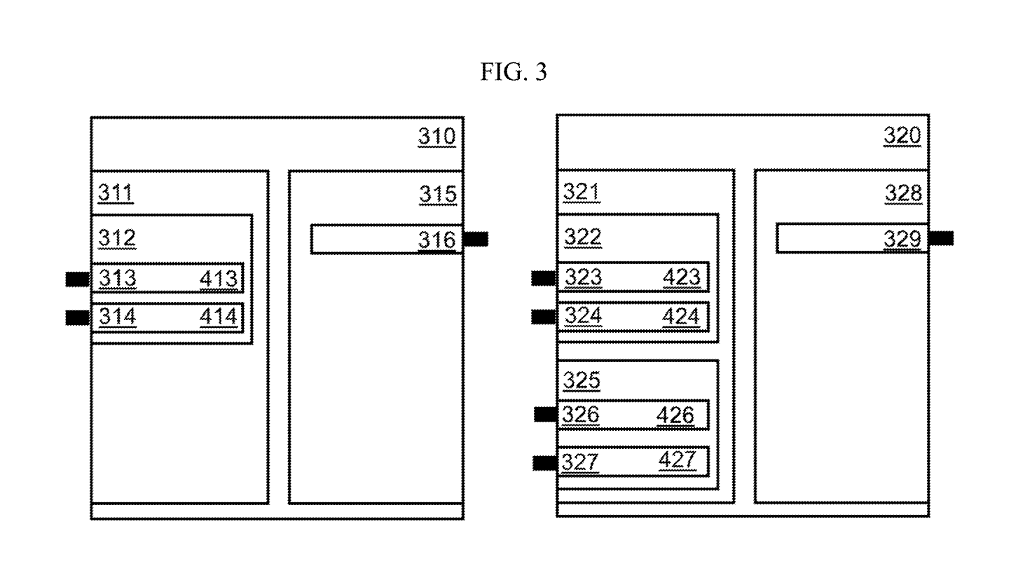

FIG. 3 shows special types of the configuration items 310 and 320 in which the configuration items have a hierarchical structure. The various hierarchical levels (311, 312, 313, 314, 315, 316) of the configuration item can in turn be understood as configuration items (311, 312, 313, 314, 315, 316). The configuration items are each a specific item type. An item type or the role of an item in terms of this invention is understood to be a technical typification of an item. Exemplary item types include input/output devices, input/output channels, input/output cards, routers, potentials, slot pins, function ports, function blocks, signal conditioning and/or logic signals. In the concrete example in FIG. 3, the configuration item 310 that is set to the highest hierarchical level can be, for example, of the type “input-output function” or “10-function”, “function block” or more specifically “voltage in/out”, “current in/out”, “analog/digital in/out” or “PWM in/out”. The configuration items 311 and 315 of the next lower hierarchical level may, for example, be of the type “electrical interface” or “model interface”. The configuration items 312 of the next lower hierarchy level may be, for example, of the type “logic signal”. The configuration items of the lowest hierarchy level may, for example, be of the type “function port”, “signal port” or “model port” and may also generally be referred to as a port. In a hierarchical structure of the configuration items, it may also be the case that a property is additionally associated with the configuration items that are hierarchically superior and/or subordinate to the configuration item that is primarily associated with the respective property.

The configuration items can be assigned properties of the test device at all hierarchical levels. In the exemplary embodiment illustrated here, the configuration items 313 and 314 are assigned the properties 413 and 414. Since the configuration items 313 and 314 are hierarchically subordinate to the configuration item 310, the properties 413 and 414 can likewise be assigned to the configuration item 310 and/or assigned to the configuration items positioned between the configuration items 310 and 314.

Accordingly, in this embodiment, the configuration items 323, 324, 326 and 327, which are hierarchically subordinate to the configuration item 320, are assigned the properties 423, 424, 426 and 427. Since configuration items 323, 324, 326, and 327 are hierarchically subordinate to configuration item 320, properties 423, 424, 246 [sic—426?], and 427 may also be assigned to configuration item 320 and/or assigned to the configuration items positioned between configuration items 320 and 323, 324, 326 or 327, respectively.

The properties can be physically stored in the test device, e.g., as data structures, file structures, function structures, program structures, variables, parameters or the like.

The configuration items at the lowest hierarchical level (e.g., 313 and 314) may also be referred to as ports. These can be connected to ports of other configuration items so as to enable data exchange or communication or signal exchange between the connected configuration items or the hardware units associated therewith. This connection can also take place automatically taking into account the properties and/or roles.

A configuration item can, for example, also be a graphic element (block, UML node, etc.) in a graphical user interface, such as a configuration diagram. A configuration item can also be a smaller part of a larger graphical element in a graphical user interface.

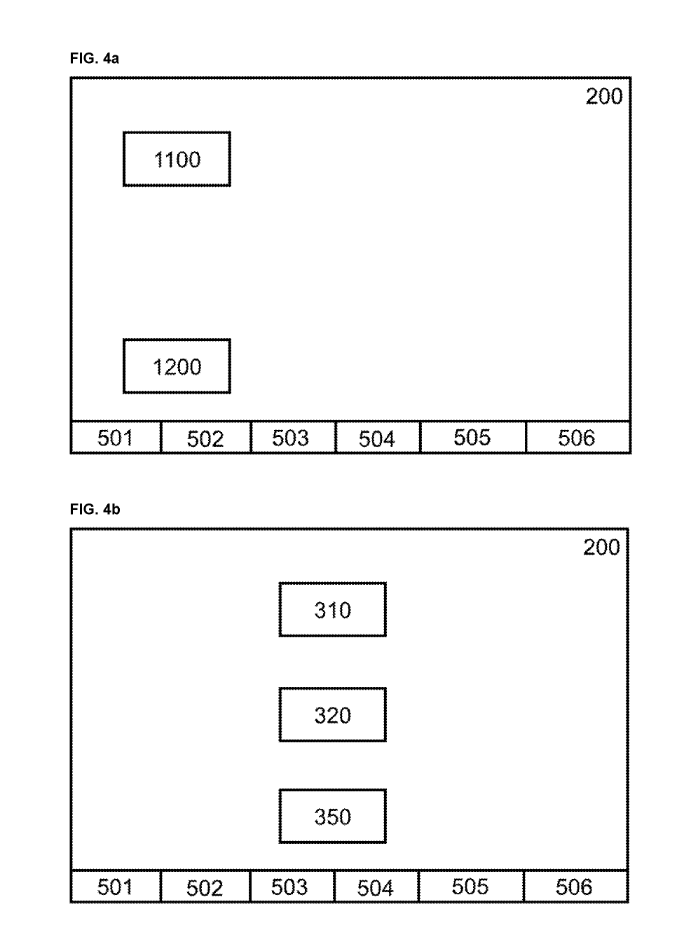

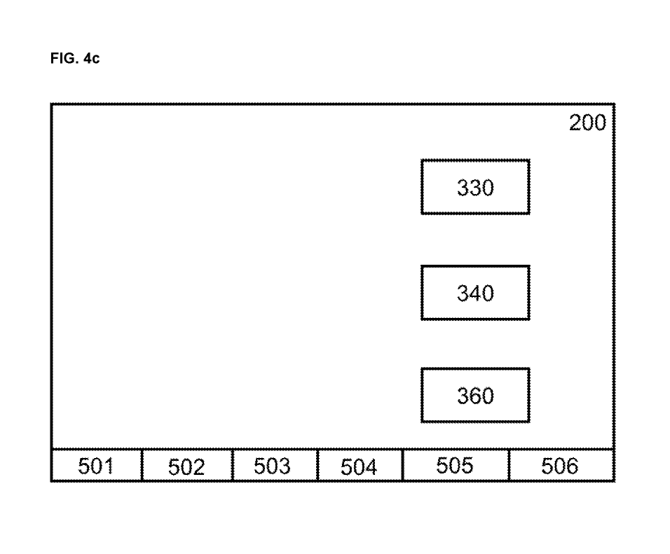

FIG. 4a schematically shows a configuration system 200 which is equipped with 6 functional panels (501, 502, 503, 504, 505, 506). FIG. 4a shows the state which results after activating the functional panel 501. In this embodiment, the functional panel has the functional category device. Therefore, after activating the functional panel 501, only the configuration items 1100 and 1200 are active.

FIG. 4b schematically shows a configuration system 200 which is equipped with 6 functional panels (501, 502, 503, 504, 505, 506). In FIG. 4b, the state is shown which results after activating the functional panel 502. In this embodiment, the functional panel has the functional category input/output interface. Therefore, after activating the functional panel 501, only the configuration items 310, 320 and 350 are active.

FIG. 4c schematically shows a configuration system 200 which is equipped with 6 functional panels (501, 502, 503, 504, 505, 506). FIG. 4c shows the state which results after activating the functional panel 503. In this embodiment, the functional panel has the functional category task. Therefore, after activating the functional panel 501, only the configuration items 330, 340 and 360 are active.

Although the invention has been described with reference to exemplary embodiments, it will be apparent to those skilled in the art that various changes may be made and equivalents may be employed without departing from the scope of the invention. The invention shall not be limited by the specific embodiments described. Rather, it includes all embodiments that are covered under the appended claims.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A configuration system of a test device configured for testing an electronic control unit, wherein the test device is a hardware-in-the-loop simulator or a rapid control prototyping simulator, the system comprising:
a software model of a technical system is executed on the test device and the software model communicates via an input/output interface of the test device with a device connected to the test device, data being transmitted electronically by the communication;
a plurality of configuration items assigned to technical functional properties of the test device and the test device and/or the communication between the connected device and the software model is configured using the technical functional properties, the configuration items being assigned a functional category, at least two of the configuration items being structured in functional panels in the configuration system; and
a separate functional panel configured for at least two of the functional categories, the separate functional panel containing only configuration items whose functional categories correspond to the functional category of the functional panel,
wherein the functional panels are positioned such that the positioning takes into account the temporal and/or causal sequence of the configuration steps,
wherein the functional panels are adapted to be activated,
wherein activating a panel results in an activation of a subset of configuration items,
wherein the subset of the configuration items and the activated functional panel have the same functional categories, and
wherein substantially simultaneously all other functional panels and configuration items are deactivated.

2. The configuration system according to claim 1, wherein the functional category defines the technical context of the configuration items to be configured.

3. The configuration system according to claim 1, wherein the configuration items are assigned one or more of the functional categories device, input/output interface, task, project, functions, signal chain, bus, multiprocessor/multicore, and build.

4. The configuration system according to claim 1, wherein the positioning of the functional panels is partially or completely one after the other, next to each other or one above the other.

5. The configuration system according to claim 1, wherein the configuration system is configured to transmit configuration data to the test device.

6. The configuration system according to claim 4, wherein the transmission is performed using a code generation and a compilation of the functional properties of the configuration items, wherein in the generated code and/or in the compiled code, the code associated with different configuration items of the same functional category is simultaneously generated, compiled and/or transmitted.

7. The configuration system according to claim 1, wherein a new functional category is assigned to a configuration item.

8. The configuration system according to claim 1, wherein a configuration item is assigned a first and a second functional category, and the configuration system is configured to activate the functional panel of the second functional category from the functional panel of the first functional category and/or highlight the configuration item in the functional panel of the second functional category.

9. A method of configuring a test device designed to test an electronic control unit via a configuration system, wherein the test device is a hardware-in-the-loop simulator or a rapid control prototyping simulator, the method comprising:
executing a software model of a technical system on the test device;
communicating by the software model communicates via an input/output interface of the test device with a device connected to the test device, data being transmitted electronically by the communication;
providing the configuration system with a plurality of configuration items, the configuration items being assigned technical functional properties of the test device and the test device and/or the communication between the connected device and the software model being configured using the technical functional properties;
assigning the configuration items a functional category;
structuring the configuration items into functional panels;
providing a separate panel for each functional category, at least two of the separate panels contain only configuration items whose functional categories correspond to the functional category of the panel; and
positioning the panels such that the positioning takes into account the temporal and/or causal sequence of the configuration steps, the panels being adapted to be activated,
wherein activating a panel activates the configuration items which are assigned the same functional categories as the activated panel, while substantially simultaneously the panels and configuration items having a different functional category are deactivated.
